(19) United States
(12) Patent Application Publication
(10) Pub. No.: US 2026/0239471 A1
(43) Pub. Date: Aug. 13, 2026

(54) METHODS FOR SELECTION AMONG A RANGE FOR A WIRELESS NETWORK CONFIGURATION PARAMETER

(71) Applicant: InterDigital Patent Holdings, Inc., Wilmington, DE (US)

(72) Inventors: Faris Alfarhan, Montreal (CA); Oumer Teyeb, Montreal (CA); Michael Starsinic, Newtown, PA (US); Yugeswar Deenoo Narayanan Thangaraj, Chalfont, PA (US); Dylan Watts, Montreal (CA); Diana Pani, Montreal (CA); Ulises Olvera-Hernandez, Saint-Lazare (CA); Ghyslain Pelletier, Montreal (CA); Martino Freda, Laval (CA); Saad Ahmad, Montreal (CA)

(73) Assignee: InterDigital Patent Holdings, Inc., Wilmington, DE (US)

(21) Appl. No.: 19/049,765

(22) Filed: Feb. 10, 2025

(51) Int. Cl. H04W 76/20; H04L 5/00; H04L 41/5009

(52) U.S. Cl. CPC H04W 76/20; H04L 5/0053; H04L 41/5009

(57) ABSTRACT

A wireless transmit/receive unit (WTRU) may receive, from a network, configuration information that is associated with a plurality of configuration parameters and may indicate one or more of an applicability range for each of the plurality of configuration parameters or a set of default and non-default values for each of the plurality of configuration parameters. The WTRU may determine that one or more conditions associated with a first configuration parameter of the plurality of configuration parameters has been met. The WTRU may change a configured value of the first configuration parameter from a first configured value to a second configured value, based on the one or more conditions being met. The WTRU may send a report to the network that indicates the second configured value of the first configuration parameter.

### BACKGROUND

The radio resource control (RRC) sublayer function includes the broadcast of System Information pertaining to access stratum (AS) and non-access stratum (NAS). The RRC sublayer also manages the establishment, maintenance, and termination of the RRC connection between a wireless transmit/receive unit (WTRU) and the network (e.g., including the radio and core parts). RRC provides a set of configuration parameters that are essential for operation of various physical (PHY), medium access control (MAC), and higher layer functions and services.

Quality of service (QoS) management functions configured by the RRC sublayer ensure the prioritization of traffic as per its significance and requirement. RRC sublayer is used to configure the radio bearers with the proper parameters that are aligned with the QoS requirements of the bearers (e.g., priorities, bit rates, delay budget, etc.). The network may ensure the WTRU gets the needed resources for the transmission of uplink (UL) data and reception of downlink (DL) data via the configuration at the RRC sublayer of semi-persistence scheduling resources (SPS), and configured grants (CG)s, respectively. Additionally, RRC sublayer specifies WTRU measurement reporting, controlling its frequency and consistency, channel state reporting, as well as ensuring rapid detection and recovery from any radio link failures. The RRC sublayer acts as a conduit for the transfer of NAS messages between NAS and WTRU, maintaining bidirectional communication integrity.

### SUMMARY

Methods and apparatuses may be described herein for selection among a configuration range of values for timers, counters, and/or other parameters.

A wireless transmit/receive unit (WTRU) may receive configuration information from a network. The configuration information may be associated with a plurality of configuration parameters. The configuration information may indicate one or more of an applicability range for each of the plurality of configuration parameters or a set of default and non-default values for each of the plurality of configuration parameters. Each of the plurality of configuration parameters may be associated with a respective information element, may be used to configure the WTRU for operation or communication with the network, and/or may include any combination of a timer or a counter. The WTRU may determine that one or more conditions associated with a first configuration parameter of the plurality of configuration parameters has been met. The WTRU may change a configured value of the first configuration parameter from a first configured value to a second configured value, for example, based on the one or more conditions being met. The second configured value may be within the applicability range for the first configuration parameter and/or a non-default value for the first configuration parameter. The WTRU may send a report to the network that indicates the second configured value of the first configuration parameter.

The WTRU may send, to the network, a request to change the configured value of the first configuration parameter from the first configured value to the second configured value, for example, prior to changing the configured value of the first configuration parameter. The first configured value may be a default value and the second configured value may be a non-default value. The one or more conditions may include reception of a grant or acknowledgment (ACK), an observed KPI is within a predetermined range, the observed KPI is greater or less than a predetermined KPI threshold, a remaining time associated with a packet is less than a threshold, a control plane (CP) event has been satisfied, a measured channel condition is within a predetermined range, a measured channel condition is greater than a predetermined threshold, and/or a measured channel condition is less than a predetermined threshold.

The configuration information may indicate one or more of a max change delta, a reporting delta, a request a change delta, or a key performance indicator (KPI) metric. The second configured value may be less than the max change delta from the first configured value. The WTRU may revert back to the first configured value based on one or more of expiration of a fallback to default value time duration, reception of a first fallback indication from the network, or satisfying a condition for fallback to default value. The WTRU may send a second fallback indication to the network that indicates that the WTRU has reverted to the first configured value. The first configured value may be a previously configured value for the first parameter or a default configured value for the first parameter. The WTRU may increment a configuration change counter associated with changing the configured value of the first configuration parameter from the first configured value to the second configured value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart illustrating an example selection among a configuration range of values for configuration parameters.

### DETAILED DESCRIPTION

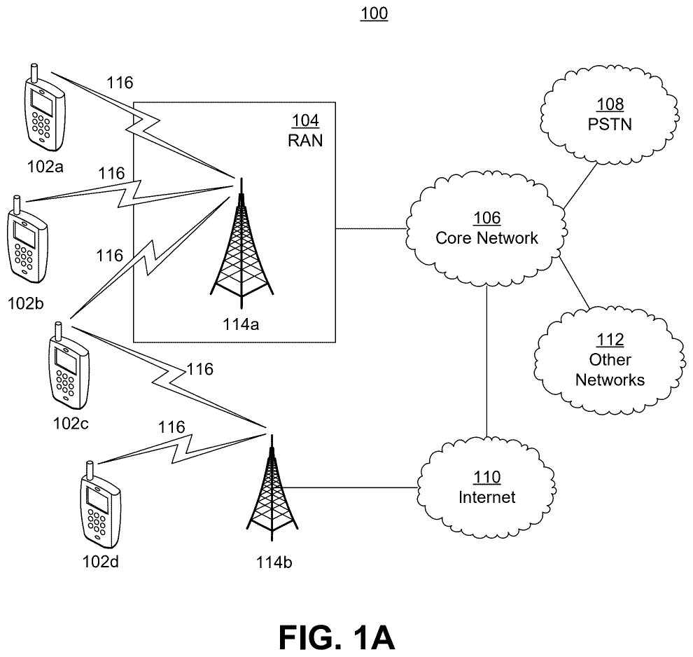

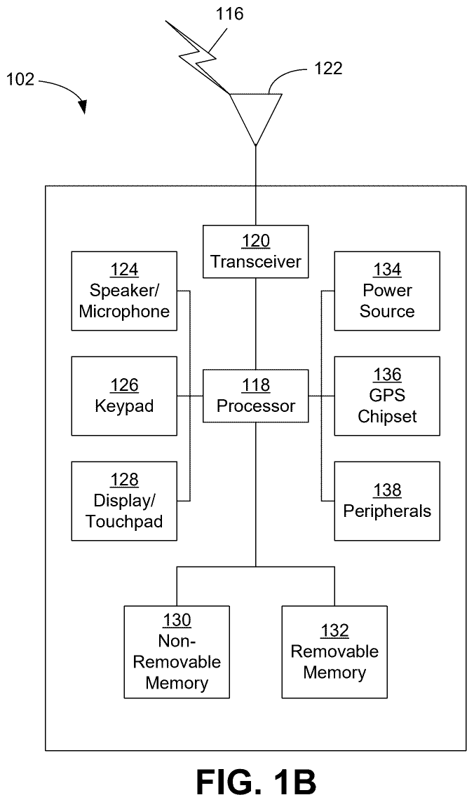

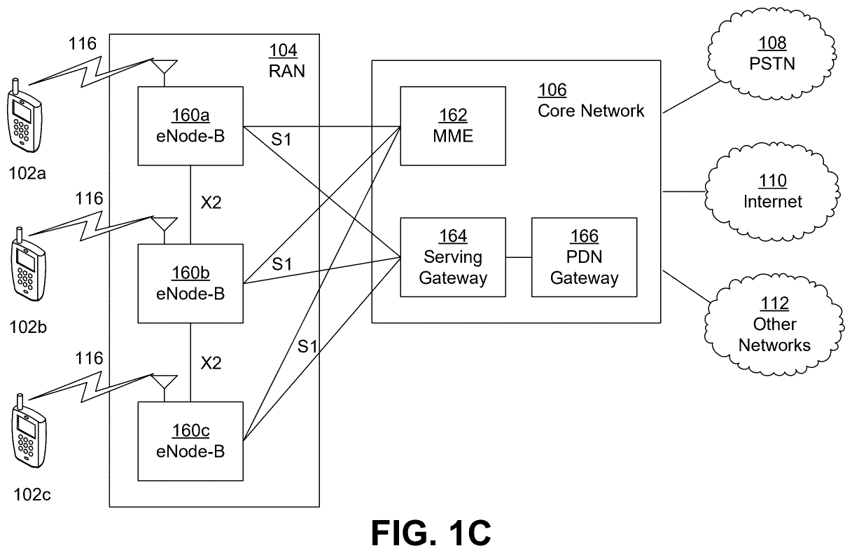

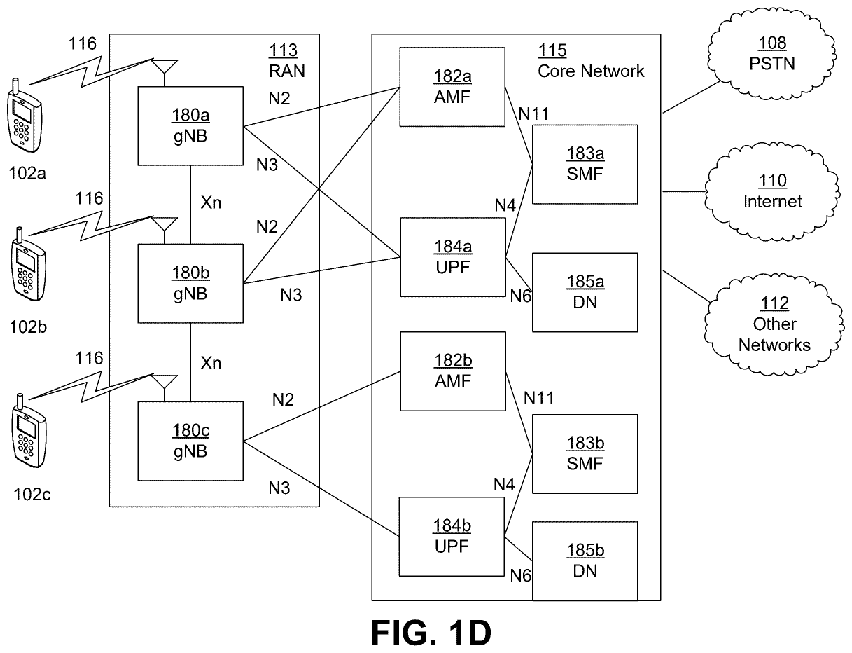

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The RRC sublayer function includes the broadcast of System Information pertaining to access stratum (AS) and non-access stratum (NAS). The RRC sublayer also manages the establishment, maintenance, and termination of the RRC connection between the WTRU and the network (e.g., including the radio and core parts). RRC provides a set of configuration parameters that are essential for operation of various PHY, MAC, and higher layer functions and services.

QoS management functions configured by the RRC sublayer ensure the prioritization of traffic as per its significance and requirement. RRC sublayer is used to configure the radio bearers with the proper parameters that are aligned with the QoS requirements of the bearers (e.g., priorities, bit rates, delay budget, etc.). The network can ensure the WTRU gets the needed resources for the transmission of UL data and reception of DL data via the configuration at the RRC sublayer of semi-persistence scheduling resources (SPS), and configured grants (CG)s, respectively. Additionally, RRC sublayer specifies WTRU measurement reporting, controlling its frequency and consistency, channel state reporting, as well as ensuring rapid detection and recovery from any radio link failures. The RRC sublayer acts as a conduit for the transfer of NAS messages between NAS and WTRU, maintaining bidirectional communication integrity.

The RRC sublayer may provide configuration of the WTRU security context of the WTRU, which includes security keys and security algorithms to be used for the encryption and integrity protection of signaling radio bearers and data ratio bearers (e.g., integrity protection). The RRC sublayer also ensures the robust establishment, configuration, and/or management of radio bearers. The RRC sublayer further specifies crucial mobility functions and operations, handovers, context transfers, cell selection and reselection in IDLE mode.

In RRC connected mode, the WTRU may be able to receive downlink data from the network in a unicast fashion and also send uplink data to the network. The network may configure the WTRU to send measurement reports periodically or when certain conditions are fulfilled and based on these reports may send the WTRU a handover command to move the WTRU to another cell/node. The WTRU can request other SI by sending a request to the network, in a dedicated manner (e.g., via UL-DCCH) and the granularity of the request is one SIB. The gNB may respond with an RRCReconfiguration including the requested SIB(s). It is a network choice to decide which requested SIBs are delivered in a dedicated or broadcasted manner.

An RRC message may be segmented in case the size of the encoded RRC message PDU exceeds a maximum PDCP SDU size. Segmentation is performed in the RRC sublayer using a separate RRC PDU to carry each segment. The receiver reassembles the segments to form the complete RRC message. One or more (e.g., all) segments of an RRC message are transmitted before sending another RRC message. Segmentation is supported in both uplink and downlink.

Abstract Syntax Notation One (ASN.1) is a standardized notation used for describing the structure of control data carried by messages exchanged between communicating entities, typically used to exchange information across an interface or communication medium. ASN.1 has been standardized internationally. It is widely used in the specification of communication protocols. ASN.1 is a mature notation with reliability and interoperability.

An example ASN.1 syntax for a subject name is shown in the below example.
Name ::=SEQUENCE OF RelativeDistinguishedName
RelativeDistinguishedName ::=SET OF AttributeTypeValue
AttributeTypeValue ::=SEQUENCE
{
   type OBJECT IDENTIFIER,
   value ANY
}

In such example, “AttributeTypeValue” is considered an Information Element (IE), while “type” or “value” is considered a configuration parameter of the IE.

One or more WTRU parameters may be configured to avoid a conservative worst case scenario. WTRU performance may be improved to link to configured parameter values (e.g., delay, PER, throughput, handovers, failure recoveries). RRC reconfiguration overhead and/or latency may be reduced. WTRU and/or network performance may be optimized for a population of WTRUs having varying capabilities.

A single value may be configured per configuration parameter. Such value (e.g., for a prohibit timer, a retransmission timer, a discard timer, a handover timer, counters for determining beam and radio link failures, etc.) may often be configured conservatively for the worst-case scenario or as a global value that accommodates all types of WTRU behaviors and reactions. This can often lead to sub-optimal performance, including e.g., delayed retransmissions, delayed discards, reduced throughputs, increased packet error rates, delayed handovers, delayed triggers of failures, and/or delayed failure recovery.

A related problem when parameters are not configured properly and/or optimally is that it can become necessary to send a series of RRC reconfigurations to the WTRU, thus causing RRC signaling overhead due to re-signalling. Reconfiguration of whole IE/ASN.1 configuration can be both large and sensitive to long delays due to possible CU-DU (Centralized Unit-Distributed Unit) architecture in the NW side and thus incur long WTRU processing times. Furthermore, the overhead scales with the number of cells, beams, LCHs, features, etc.

A WTRU may be configured with a range of values for a given RRC reconfigurable parameters, along with a default value and conditions/constraints on when and how the parameter can be modified (e.g., how often, if the parameter can be changed autonomously or requires network confirmation, etc.). Upon determining the need for the change of the parameter value, the WTRU either autonomously updates the parameter to the determined value (e.g., and inform the network) and/or sends a request to the network requesting a change to the new value.

This framework allows for adaptation among RAN config parameters (e.g., including UP and PHY parameters, CP and NAS procedures), for example, to give WTRUs some leeway to select and/or suggest a value among a configured range based on AI or meeting a condition for using a non-default config value. One or more of the following scenarios may apply.

In an example WTRU autonomous procedure, the WTRU may change the parameter value and the network does not need to know (e.g., no WTRU feedback or implicit feedback based on WTRU behavior/state).

In another example WTRU autonomous procedure, the WTRU may change the parameter value and the network needs to know that a change has happened. The change may be reported immediately or reported in the next UL message that the WTRU sends to the network.

In another example WTRU autonomous procedure, the WTRU may change the parameter value and the network needs to know the chosen non-default value. The WTRU may report the selected value and/or the change delta to the network, for example, each time the WTRU changes a parameter value. The change may be reported immediately or reported in the next message that the WTRU sends to the network. Additionally or alternatively, the change may be implemented (e.g., implemented only) after receiving ACK or after a timer has expired.

In an example network-controlled procedure, the WTRU may request to change and the network needs to know about the proposed change.

In another example network-controlled procedure, the WTRU may receive a NACK or an ACK about the request. The WTRU may change the configured value upon (e.g., only upon) reception of an ACK from the network (e.g., granting the change request). If no response is received within a given time after the request is sent, the WTRU may assume (e.g., implicitly assume) it is a NACK and the WTRU keeps on using the previous value. If no response is received within a given time after the request is sent, the WTRU may assume (e.g., implicitly assume) it is an ACK and the WTRU applies the modification

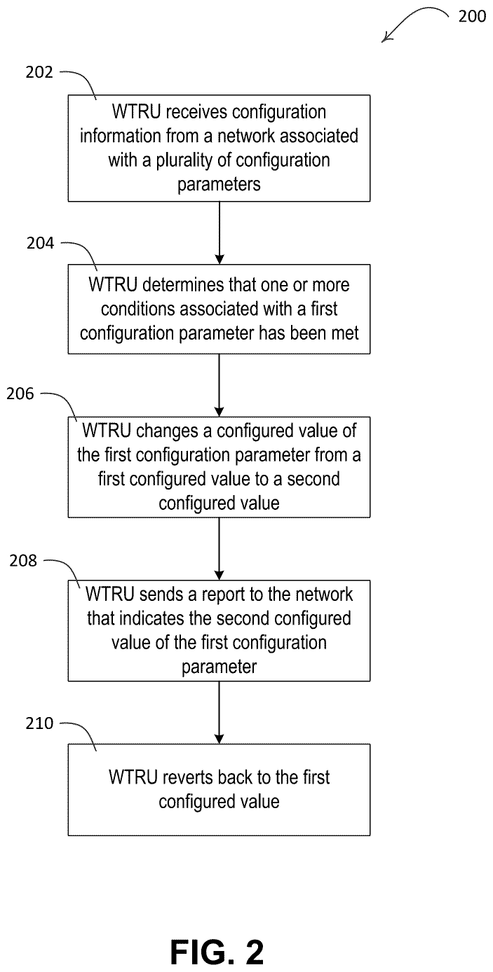

FIG. 2 depicts an example selection 200 among a configuration range of values for configuration parameters. At 202, a WTRU may be configured with a subset of configuration parameters. For example, the WTRU may receive, at 202, from a network, configuration information associated with a plurality of configuration parameters. The configuration information may indicate one or more of an applicability range for each of the plurality of configuration parameters or a set of default and non-default values for each of the plurality of configuration parameters. Each of the plurality of configuration parameters may be associated with a respective information element, may be used to configure the WTRU for operation or communication with the network, and/or may comprise any combination of a timer or a counter. Each configuration parameter may be configured with an applicability range with a multitude of values and/or a set of default and non-default values. The applicability range may be configured as a single value configuration+/−a delta range, or as a min/max range. The WTRU may be provided with a default value (e.g., t1), and a multitude of other non-default values (e.g., timer x={t2, t3, t4, . . . , tn}). Each parameter may be configured with a maximum change delta. The maximum change delta may represent a maximum value the WTRU can change from the default value at a given time. Each parameter may be configured with a reporting delta. The reporting delta may represent the change delta relative to the configured/default value at which the WTRU reports to the network the change of value and/or selected value. Each parameter may be configured with a request a change delta. The WTRU may request to change a configured value if the desired value is more than (e.g., a request a change delta) from the configured/default value. Each parameter may be configured with a KPI reporting metric. The KPI reporting metric may be associated with the KPI is reported periodically once a non-default value is selected/requested or a KPI is used to condition the parameter value change.

At 204, the WTRU may determine that one or more conditions associated with at least a first configuration parameter of the plurality of configuration parameters has been met. The one or more conditions may be associated with changing one or more values of a variable configuration value. The WTRU may perform one or more of the following. The WTRU may request to change a configured value to a non-default value (e.g., a value within the configured range), for example, if one or more conditions for requesting a configuration change to a non-default value has been met. The WTRU may report a KPI associated with the requested parameter value change. The WTRU may request a change beyond a configured non-default value (e.g., out of range).

At 206, the WTRU may select and/or change a configured value to a non-default value (e.g., a value within the configured range), for example, if one or more conditions for WTRU autonomous change of configuration to a non-default value has been met. The one or more conditions may include reception of a grant or acknowledgment (ACK), an observed KPI is within a predetermined range, the observed KPI is greater or less than a predetermined KPI threshold, a remaining time associated with a packet is less than a threshold, a control plane (CP) event has been satisfied, a measured channel condition is within a predetermined range, a measured channel condition is greater than a predetermined threshold, and/or the measured channel condition is less than a predetermined threshold.

For example, the WTRU may change the configured value of the first configuration parameter from a first configured value (e.g., such as a default value) to a second configuration value (e.g., such as a non-default value for the first configuration parameter and/or a value within the applicability range for the first configuration parameter). The WTRU may change the configured value by an amount that does not exceed the max change delta, if configured. The WTRU may select a non-default value based on a WTRU-sided model (e.g., AIML based model, statistical model, etc.). The WTRU may start a WTRU autonomous selection prohibit timer, for example, to limit such action while the timer is running. The WTRU may increment a counter associated with the parameter being changed. For example, the WTRU may be configured to make a maximum number of parameter changes (e.g., within a given time duration, etc.). The WTRU may start a fallback to default value timer. The WTRU may select and/or change the configured value based on transmitting a request to change a configured value (e.g., if applicable/configured) and/or receiving a command from the network granting and/or acknowledging the request (e.g., an RCE) for a subset of parameters.

At 208, the WTRU may report the change to the network, for example, upon changing a configured value and/or selecting a non-default value. For example, the WTRU may send a report to the network that indicates the second configured value of the first configuration parameter. The WTRU may report the change to the network if one or more conditions for reporting a change of configuration to a non-default value has been met. For example, the WTRU may report that the WTRU has selected a non-default value/changed the configuration, that the WTRU selected a non-default configuration value, and/or the change delta. The WTRU may report one or more KPIs (e.g., QoE level/PER, UE state, memory state, etc.) associated with the change.

At 210, the WTRU may fall back (e.g., revert) to a previously configured value or the default value after expiry of the fallback to default value time duration, for example, upon reception of a fallback indication from the network (e.g., in a MAC CE, RCE, or an indication by DCI) and/or upon meeting one or more conditions for fallback to default configuration value. The WTRU may indicate to the network that the WTRU has reverted to the previously configured value or the default value. The indication from the network may turn off a WTRU autonomous parameter value change operation and/or prohibit the WTRU autonomous parameter value change operation for a configured period.

WTRU selection among a configuration range of values for timers and/or parameters may enable one or more of improved WTRU performance, improved network performance, reduced RRC configuration overhead, improved latency and throughput, improved WTRU memory management, WTRU power saving, or faster adaptation to channel failures and changes.

The following terminology may be used herein. Channel conditions may be used herein to refer to any conditions relating to the state of the radio/channel. The channel conditions may be determined by the WTRU from: a WTRU measurement (e.g., L1/SINR/RSRP, CQI/MCS, channel occupancy, RSSI, power headroom, exposure headroom), L3/mobility-based measurements (e.g., RSRP, RSRQ, s-measure), an RLM state, and/or a channel availability in unlicensed spectrum (e.g., whether the channel is occupied based on determination of an LBT procedure or whether the channel is deemed to have experienced a consistent LBT failure).

UCI may be used herein to refer to uplink control information. UCI may include: CSI, HARQ feedback for one or more HARQ processes, Scheduling request (SR), Link recovery request (LRR), CG-UCI, and/or other control information bits that may be transmitted on the PUCCH or PUSCH.

MAC Radio Control Element, Radio Control MAC CE (MAC RCE), and/or Radio Control Element (RCE) may be used to describe (e.g., generally describe) a downlink or uplink control message transmitted by intermediate layer protocols (e.g., MAC or another L2 layer). The downlink or uplink control message may provide some or all of configuration or configuration parameters typically provided by semi-static signalling (e.g., RRC configuration), possibly over multiple segments (e.g., PDUs).

KPI may be used herein to refer to a key performance indicator used to evaluate a performance metric of the WTRU in a wireless network and/or the performance of a model (e.g., an AIML model, statistical model, etc.) that the WTRU uses to determine optimal parameter values. KPIs may include a throughput or a bit rate, a WTRU memory state, a number of occupied HARQ processes, a packet error rate (PER), a packet loss rate, a block error rate (BLER), a latency, a delay bound, a reliability level, a guaranteed bit rate, an average bit rate, a channel measurement value or related counter, a channel failure counter, and/or a handover related measured metric/event/timer/counter.

WTRU state may be used herein to refer to a state related to the WTRU's power consumption, NW energy saving state, a NW congestion state, a memory consumption state, a CPU consumption state, a WTRU overheating state, a throughput capacity, and/or an associated capability or an ability to support a feature of a combination of features.

A property of scheduling information (e.g., an uplink grant or a downlink assignment) may include one or more of a frequency allocation, an aspect of time allocation (e.g., such as time instance or/and a time duration), a priority; a modulation and coding scheme, a transport block size, a number of spatial layers, a number of transport blocks to be carried, a TCI state or SRI, a number of repetitions, and/or a grant type. The grant type may indicate whether the grant is a configured grant type 1 (e.g., WTRU immediately using the configured UL resources after receiving the configuration information), type 2 (e.g., WTRU waiting until an explicit MAC CE indication before using the configured UL resources), or a dynamic grant.

An indication by DCI, or an indication, may include one or more of an explicit indication by a DCI field or by RNTI used to mask CRC of the PDCCH, an implicit indication by a property (e.g., such as DCI format, DCI size, Coreset or search space, aggregation level, or identity of first control channel resource (e.g., index of first CCE) for a DCI). A mapping between the property and the value may be signaled by RRC or MAC. An explicit indication by a DL MAC CE may be provided.

An LCH and data flows may be used interchangeably herein. It should be noted that while a SDU is defined herein as a unit to evaluate, SDU is not limited to pure SDU level evaluation but the same conditions may apply in evaluation of a remaining segment of an SDU. An SDU may refer herein to a data unit or a packet, which may include SDU or a segment of a SDU.

In a sample data plane architecture framework, an application may provide one or more IP flows for transmission over a medium. Each of the one or more IP flows may go through a transport layer protocol (e.g., TCP/IP, QUIC, RTP, MOC, etc.). Each of the one or more IP flows (e.g., a PDU session) may go through a RAN core network, which maps a respective IP flow to a RAN data flow and/or a RAN data set. For each RAN data flow, the core network may attach one or more QoS requirements, a QoS metric, and/or a range of QoE metrics.

A RAN data flow may represent a logical association between data packets and/or units, e.g., originating from the same IP flow. Such association may be based on such data units being associated to the same IP flow, application flow, and/or having the same association packet marked either by the core network or the application.

The WTRU may assign a QoS class to each data unit within a RAN data flow for the purpose of characterization of how data should be transmitted. A data protocol plane may include a data unit classification function for QoS/QoE marking throughout the protocol chain. The QoS/QoE class may be determined in such layer according to one or more configured or predefined rules. Such QoS class may be used in various layers within the data plan protocol chain for achieving a certain QoS requirement and/or a QoE level. A QoS class may indicate a part of a protocol layer header. Each QoS class may be associated with a QoS treatment profile in the RAN, which may be configured semi-statically. Each QoS treatment profile may include a number of parameters to control the RAN treatment of the data transmission/reception and/or a number of metrics to achieve the QoE level for a given layer in the protocol chain. Each QoS class or QoS treatment profile may be associated and/or configured with a priority index, an importance level, a delay bound, a reliability level, a guaranteed bit rate, a maximum bit rate, and/or a maximum packet loss rate.

Dynamic control of configuration parameters may reduce RRC signaling overhead and/or allow faster application of re-configuration. In examples, dynamic signaling, in the form of a Radio control element (RCE) may change one or more RRC configuration parameters, or a subset thereof, for example, without having to introduce ASN1 style in MAC. The RCE may include a MAC control element, an indication by DCI, and/or a property of the scheduling DCI. Control functions may be moved to MAC signaling without having to indicate IE configurations in the MAC CE. The RCE may control a subset of the configured IEs by RRC.

The WTRU may be configured with a plurality of configurations. Each of the plurality of configurations may include associated configuration parameters that are applicable to the container. Each container may be identified by a name, a number, and/or an index. The WTRU may receive signaling indicating a subset of the configuration containers and/or configuration parameters. The signaling may be received via a MAC RCE or an RCE. The RCE may indicate a subset of configuration containers. For each indicated configuration container, the RCE may indicate a subset of configuration parameters that are (re)-configured by RCE indication. The WTRU may assume one or more configuration values that are indicated as part of the RCE rather than by semi-static configurations (e.g., RRC). The RCE may indicate a delta from the configured value (e.g., default value). For a configuration parameter that is indicated by an RCE, the WTRU may assume that the configuration parameter is altered going forward (e.g., permanently or semi-statically until altered again), for a limited period of time. The period of time may be configured by higher layer signaling (e.g., RRC), predefined, and/or indicated as part of the RCE. Upon expiry of such period, the WTRU may revert to the configurated semi-static value by higher layer signaling (e.g., RRC). The RCE index may include one or more hierarchies. For example, a top level hierarchy may indicate the configuration container and a lower-level hierarchy may indicate the configuration parameter.

The WTRU may generate an uplink confirmation MAC CE or an uplink RCE, for example, if at least one of the following has been met. The WTRU may generate an uplink confirmation MAC CE or an uplink RCE upon reception of a downlink MAC RCE. The Radio Control MAC CE may provide a configuration/confirmation ID which is replicated by the WTRU in the confirmation MAC CE to ensure multiple configurations can be run in parallel. The WTRU may generate an uplink confirmation MAC CE or an uplink RCE upon reception of a trigger/indication from higher layers (e.g., RRC) to transmit control information over an intermediate layer (e.g., MAC). The WTRU may generate an uplink confirmation MAC CE or an uplink RCE to request to change a semi-statically configured parameter. The WTRU may generate an uplink confirmation MAC CE or an uplink RCE to transmit one or more of RRC configuration parameter(s) (e.g., or a subset thereof) (e.g., abstracted by an uplink RCE). The WTRU may generate an uplink confirmation MAC CE or an uplink RCE to report a control plane event as described herein (e.g., failure or handover) and/or to report that a configuration parameter or a related KPI is operating in a sub-optimal range.

In examples, the WTRU may be configured with a RCE to indicate a downlink control message transmitted by a layer-2-layer protocol (e.g., MAC) signalling. The WTRU may be configured semi-statically with a plurality of configuration containers. Each of the plurality of configuration containers may include configuration parameters, associated configuration values, and/or an index. For each configuration container, the WTRU may be configured semi-statically with an index, whether the WTRU can be indicated by a RCE, and/or associated configuration parameters then can be altered by an RCE. The WTRU may receive an RCE indicating one or more RCE components. Each of the one or more RCE components may correspond to a configuration container index. Each of the one or more RCE components may provide configuration for some or all configuration parameters for the associated configuration container. The WTRU may transmit a confirmation MAC CE/RCE, for example, upon reception of an RCE. The WTRU may apply the configuration indicated in the RCE, for example, upon reception of an RCE or an acknowledgement corresponding to the UL confirmation MAC CE.

A configuration and/or one or more conditions may be provided for requesting and/or changing a parameter value. The WTRU may be configured with a subset of configuration parameters. Each configuration parameter may be configured with an applicability range with a plurality of values and/or a set of default and non-default values, including one or more of the following. The applicability range may be configured as a single value configuration+/−a delta range, or as a min/max range. The WTRU may be configured with multiple applicability ranges. Each applicability range may be applicable if an association condition(s) has been met. The WTRU may be provided with a default value (e.g., t1) and/or a plurality of non-default values (e.g., timer x={t2, t3, t4, . . . , tn}. The default and/or non-default value(s) may be provided by RRC and/or by dynamic signaling (e.g., DCI). The first value can be considered a default/initial value. Additionally or alternatively, the initial value may be configured separately/explicitly. A subset of the configurations may be indicated and/or reconfigured dynamically by the network (e.g., by an RCE). The subset of configs can be limited to certain DRBs/LCHs and/or data types. The WTRU may be configured with priorities for non-default values, for example, to prioritize the selection amongst non-default values. In examples, the network may provide a list and/or range of non-default values in dynamic signaling (e.g., DCI or MAC CE). Non-default values may be applicable to a given grant, assignment, DCI, and/or a given period associated with the indication.

Each parameter may be configured with a max change delta. The max change delta may be a maximum value the WTRU may change from the default value at a given time. Each parameter may be configured with a reporting delta. The reporting delta may be a change delta relative to the configured/default value at which the WTRU reports to the network the change of value and/or selected value. Each parameter may be configured with a request a change delta. The request a change delta may indicate a change value where the WTRU may request to change a configured value if the desired value is more than the change value (e.g., the request a change delta) from the configured/default value. Each parameter (e.g., or group of parameters) may be configured with a KPI and/or an associated metric to monitor. The WTRU may trigger the change of the parameter value and/or send a request to change the parameter value based on a value of the KPI metric (e.g., when the KPI metric value falls below a certain threshold, becomes greater than a certain threshold, within a specified or configured range etc.).

Each parameter (e.g., or group of parameters) may be configured with an associated KPI metric to report. The associated KPI metric to report may be the same as or different from the KPI metric to monitor. The WTRU may report the associated KPI metric periodically and/or when the reporting KPI metric value meets certain conditions (e.g., within a threshold, lower than a threshold, above a threshold, and/or if the value is used for more than a certain time duration). Additionally or alternatively, the WTRU may report the associated KPI metric when the parameter is assigned a non-default value (e.g., autonomously selected by the WTRU, approved by the network after WTRU has requested it, etc.). The WTRU may be configured with one or more restrictions on which parameters can be changed autonomously, which parameters can be changed after a request, which parameters can be value changed after requesting and receiving an ACK/RCE from the network, and/or which parameters the WTRU can request a change or cannot change (e.g., single configuration value only).

A procedure (e.g., a related procedure) that is ongoing based on the previous parameter values may need to be finalized before the new value can be applied. For such parameters, the WTRU may be configured or specified with acceptable times during which the WTRU can change the value. Each parameter may be configured with a fallback to default value timer. The WTRU may fall back to the single default value, for example, when the fallback to default value timer expires. The WTRU may restart the timer (e.g., the fallback to default value timer) upon receiving an acknowledgement from the network or meeting an associated KPI (e.g., being within a given range). Each parameter may be configured with a response timer, for example, as a condition to change to a non-default value. The response timer may start upon transmitting a request to change the parameter value and/or receiving a reply from the network. Each parameter may be configured with a WTRU autonomous change prohibit timer. The WTRU autonomous change prohibit timer values may be common to one or more (e.g., all) dynamic parameters that may change, be individual, or be dependent on the delta between the current and new value. A higher delta may require a longer prohibit timer value (e.g., a table of prohibit timer value and change delta can be configured).

In examples, the configuration of the default value of a parameter may be indicated in the 3GPP specifications. A range of other possible values may be signalled to the WTRU. For example, the WTRU may start using the default value indicated in the 3GPP specifications (e.g., RRC/PDCP/RLC/MAC/PHY specifications) and may determine to change the value to any of the other possible values (e.g., or request the change) later.

In examples, the configuration of the default value as well as the possible values for a parameter may be indicated in the 3GPP specifications. For example, if a parameter is a mandatory parameter, there may be no need to signal default value or range of values. If a parameter is an optional parameter, an indication (e.g., a Boolean indication) of whether this parameter is to be used or not may be signalled to the WTRU.

A condition for changing a parameter value or requesting the change of the parameter value may depend on the parameter type, the amount of value change, and/or the scenario.

A WTRU may be configured with one or more of the following conditions for changing the parameter value and/or requesting the change of a parameter value. The conditions for changing the parameter value and/or requesting the change of a parameter value may include a reception of DL signaling or an RCE that indicates a specific KPI, NW/cell congestion, and/or to allow the WTRU to suggest a different configuration or autonomously change the configuration value. The conditions for changing the parameter value and/or requesting the change of a parameter value may include a reception of a grant/ACK in response to a change request for a parameter value change. The WTRU may change the value based on transmitting a request to change a configured value (e.g., if applicable/configured) and/or receiving a command from the network granting and/or acknowledging the request (e.g., an RCE) for a subset of parameters. The conditions for changing the parameter value and/or requesting the change of a parameter value may include an observed KPI (e.g., PER ratio, FEC ratio, etc.). The WTRU may request a change to the configured parameter if the observed KPI (e.g., associated with the parameter) is within a range, lower than a threshold, or larger than a threshold. The conditions for changing the parameter value and/or requesting the change of a parameter value may include a remaining time associated with a packet/SDU. The WTRU may request a change to the configured parameter, for example, if the remaining time is less than a threshold. The remaining time may be associated with the time remaining until a packet is discarded or an associated discard timer expires. The conditions for changing the parameter value and/or requesting the change of a parameter value may include a presence of dependent data for transmission. For example, in multi-modality, value 1 may be used when dependent data x from associated flow xx is available for transmission/transmitted/received. Value 2 may be used otherwise (e.g., an LCH priority). In PDU sets, value 1 may be used when PDU x from associated PDU set is available for transmission/transmitted/received. Value 2 may be used otherwise. The conditions for changing the parameter value and/or requesting the change of a parameter value may include satisfying a CP event (e.g., CHO event met, failure event triggered, beam failure, beam failure count > or < a threshold, etc.). The CP event may include RLF, beam failure, and/or the WTRU not being able to decode network signalling.

[symbol] conditions for changing the parameter value and/or requesting the change of a parameter value may include a WTRU state (e.g., WTRU memory/buffer headroom, WTRU power consumption/savings state, WTRU overheating state, a CPU consumption state, etc. For example, the WTRU may choose or request value 1 in state A, value 2 in state B, and so on. The conditions for changing the parameter value and/or requesting the change of a parameter value may include interactions with the application/API (e.g., such as reception of an up/down QoE level). For example, the WTRU may choose value 1 or range 1 if an indication from an API is received or when the WTRU is in QoE level A, value 2 or range 2 in QoE level B, and so on. The conditions for changing the parameter value and/or requesting the change of a parameter value may include channel related conditions and measurements. For example, the WTRU may choose amongst a non-default value(s) or a non default range if measured channel conditions are below a threshold, above a threshold, or within a range. For example, if measured {RSRP, RSRQ, SINR, CQI, power headroom} is > or < a threshold or in range x, the WTRU may use value 1 or a value within range 1, otherwise the WTRU may use value 2 or a value within range 2. The conditions for changing the parameter value and/or requesting the change of a parameter value may include a subscription based condition or policy-based conditions (e.g., dedicated by the operator). The conditions for changing the parameter value and/or requesting the change of a parameter value may include a KPI (e.g., BLER, PER, tput) improving by x margin within a window since change. For example, the WTRU may use a non-default value x if the non-default value x can improve an associated KPI by more than a margin or by a percentage that is configured, possibly during a window. The WTRU may be configured with a KPI to non-default value range look-up table. Each non-default value may be used/requested if the KPI is measured within such range.

The conditions for changing the parameter value and/or requesting the change of a parameter value may include a function of the WTRU being in a given RRC state or upon state transition (e.g., going from INACTIVE to CONNECTED, etc.). For example, the WTRU may use value 1 or range 1 in connected mode, value 2 or range 2 in IDLE mode, value 3 or range 3 in INACTIVE state, and so on. The conditions for changing the parameter value and/or requesting the change of a parameter value may include the NW signalling a configuration change that is not aligned with the WTRU change (e.g., fallback or request condition). For example, the WTRU may fallback to a value signalled by the network if the WTRU has autonomously changed it to a non-default value that is not within range of the signalled value by the network (e.g., in an RCE). The selected non-default value by the WTRU may depend on network signalling, e.g., based on the values indicated in an RCE or within a compatibility range. The conditions for changing the parameter value and/or requesting the change of a parameter value may include a change delta being less than or greater than a threshold. The conditions for changing the parameter value and/or requesting the change of a parameter value may include the physical layer resource being used. A condition for a parameter value change can be met (e.g., or a given non-default value) may be (e.g., only be) applicable in a subset of physical layer resources (e.g., bwp, or radio resource). For example, value 1 and/or range 1 may be applicable to bwp/carrier 1, value 2 and/or range 2 may be applicable to bwp 2, and so on. A range may be applicable as a function of active antenna elements or ports.

A subset of these conditions may applicable to request conditions, reporting conditions, WTRU autonomous parameter change conditions, and/or fallback conditions. One or more of these conditions may configured/applicable to a given configuration parameter.

A WTRU may request to change a parameter value. The WTRU may request to change a configured value to a non-default value (e.g., a value within the configured range), for example, if one or more conditions for requesting a configuration change to a non-default value has been met. Additionally or alternatively, the WTRU may use a model (e.g., an AIML model, a statical model) to determine the optimal parameter value to use at a certain point in time.

The WTRU may be configured to send a request for a change of a parameter value, as described herein. The request for a change of a parameter value may be signalled via an indication indicating that the WTRU is recommending the parameter to be changed (e.g., without any parameter value). The indication indicating that the WTRU is recommending the parameter to be changed may include one or more of the following. indication indicating that the WTRU is recommending the parameter to be changed may include a reason for the change request (e.g., associated KPI metric conditions for requesting a change are fulfilled, decision is made based on a UE AIML model, etc.). The indication indicating that the WTRU is recommending the parameter to be changed may include a value of KPI metric that led to the WTRU's decision to request the change. The WTRU may report a KPI associated with the requested parameter value change. The WTRU may provide KPIs (e.g., QoE level/PER, WTRU state, memory state, etc.) and/or WTRU assistance information, for example, to suggest changing configured range. The indication indicating that the WTRU is recommending the parameter to be changed may include an enquiry from WTRU about a network KPI (e.g., a congestion level, a network energy saving state, a network state for broadcast of common signals/channels). The indication indicating that the WTRU is recommending the parameter to be changed may include a value, value range, or set of values the WTRU is requesting the parameter to be changed to. The indication indicating that the WTRU is recommending the parameter to be changed may include a delta value from the current value being used (e.g., or the default value) that the WTRU is requesting the change to. The indication indicating that the WTRU is recommending the parameter to be changed may include a request to change a parameter configuration out of range (e.g., a MAC CE/UAI to indicate a value or a delta). A suggestion from the WTRU to reconfigure a range of configurations (e.g., by UAI) may be provided.

The request to the network may be sent via RRC messaging (e.g., enhanced WTRU Assistance Information, UAI, message, a new UL RRC reconfiguration request message, etc.), a MAC CE, a UCI, etc.

The WTRU may monitor for a reply from the network following the transmission of a request to change a parameter value. For example, the WTRU may perform PDCCH monitoring or monitoring for RCE/RRC reconfiguration. The WTRU may receive a confirmation or rejection to a dynamic config parameter change DL command (e.g., reception of an acknowledgment to grant a request, or an RCE).

Upon reception of a reply, the WTRU may conditionally apply a non-default config based on successful reception of a confirmation/ACK/grant to the WTRU request to change parameter value. The confirmation may be parameter dependent.

The network may provide the WTRU with a new value to use for a parameter, for example, if the WTRU has sent a request for a change of a parameter value (e.g., without indicating a preferred value).

The network may provide a simple ACK/NACK to a request, for example, if the WTRU has sent the request for a change of parameter value and/or indicated a given value (e.g., or a delta from the current value or the default value). Additionally or alternatively, even though the WTRU has indicated a preferred value, the network may indicate to the WTRU a value that is different from the preferred value in the confirmation message.

The network may indicate to the WTRU a value to choose from among the values that the WTRU has indicated (e.g., the actual value, an index to the value range, etc.), for example, if the WTRU has sent a request for a change of a parameter value and/or indicated a range of values (e.g., or delta values from the current value or the default value). Additionally or alternatively, the network may indicate to the WTRU to use a value outside the indicated preferred range or set of values. The confirmation and/or rejection indication from the network could be via RRC, RCE, MAC CE, or DCI signaling.

WTRU autonomous change and reporting of a configuration parameter value may be provided. The WTRU may be configured to select and/or change a parameter's value (e.g., from the current value, which can be the default value or another configured value, to another non-default value, e.g., a value within the configured range/set), for example, if one or more conditions for WTRU autonomous change of configuration to a non-default value has been met (e.g., according to any of the conditions described herein). In some examples, the UE may inform the network about the change. In other examples, the UE may not inform the network about the change.

Each parameter (e.g., or group of parameters) may be configured with an associated KPI metric to monitor. The WTRU may be configured with conditions and/or constraints that the KPI must satisfy for the WTRU to be able to change a parameter's value and/or trigger a request for the change to the parameter's value. For example, the WTRU may be configured with a default value for a parameter, a range/set of other values for the parameter, a KPI associated with the parameter, and/or one or more thresholds associated with the parameter. If the KPI metric falls below the threshold while using the default value for that parameter for a certain configured duration, the WTRU may change the parameter value to a non-default value. The WTRU may change the configured value by an amount that does not exceed a max change delta, if configured.

The WTRU may be configured to change the parameter value to a non-default value, but afterwards the KPI must fulfill certain configured thresholds (e.g., within a given time after the change of the parameter value) for the WTRU to keep using the new value. Otherwise, the WTRU may be configured to revert to the default value or the previous value before the change. The KPI metric to report/monitor may be common to more than one (e.g., all) parameters.

The WTRU may be configured to change the value of a certain number (e.g., only a certain number) of parameters (e.g., or request a change for those parameters) from their non-default values at a given time. For example, the certain number of parameters may include any parameters or parameters within a group of parameters that are associated with the same KPI metric. For example, if the WTRU changes the values of two different parameters that can affect the throughput and the throughput is impacted, the WTRU may not be able to identify which parameter change is causing the problem.

The WTRU may be configured to change the parameter value (e.g., for one parameter, parameters within a group, within all parameters) or request the change for the parameters, by not more than a configured number of times (e.g., within a configured time duration). For example, the WTRU may be limited to a configured number of parameter value changes and/or parameter value change requests. Additionally or alternatively, the WTRU may be configured with a maximum number of times that the WTRU can change a certain parameter value and/or request the change of the certain parameter value of a certain parameter. Additionally or alternatively, the WTRU may be configured with a maximum number of total changes and/or change requests for a plurality of (e.g., all) parameters.

In examples, there may be a relationship between different parameters and their values. For example, the WTRU may be configured with a relationship indicating that if the value of parameter1 is changed to a certain value (e.g., or a subset of the possible values that parameter1 can take), then parameter2 must be changed to a certain value (e.g., or subset of the possible values that parameter2 can take). Additionally or alternatively, the WTRU may be configured not to be able to change the value of parameter1, for example, as long as the value of another parameter (e.g., parameter2) is not within a certain subset of the possible values that parameter2 can take.

In a radio link failure parameter example, The WTRU may be configured to have the option to select several values for N310 (e.g., a number of consecutive out of sync the physical layer have to detect with the serving cell before determining the radio link is having a problem and starting the T310 timer) and/or several values for N311 (e.g., a number of consecutive in sync the physical layer have to detect after T310 has started to determine that the link has recovered). If the WTRU has determined to change the value of the N310 to use, the WTRU may be configured to also change the value of N311 and/or the T310 timer value. For example, the WTRU may be configured to change (e.g., directly change) the N310 value. For each N310 value it can take, there may be a mapping to an N311 value and/or a T310 value. The WTRU may change the N311 and/or T310 timer value to respective values mapped to the determined N310 value, for example, when determining to change the N310 value.

The WTRU may be configured with a minimum time duration (e.g., after a certain parameter is configured for the first time or the value is explicitly changed by the network, etc.) to use a value before changing the value and/or requesting to change the value. The minimum time duration may be the same for a plurality of (e.g., all) parameters. The minimum time duration may be the same for a subset of the parameters. The minimum time duration may be different for each parameter.

The WTRU may start a prohibit timer for changing a parameter, for example, upon changing the value or wait until request is ACK/grant received from the network. Restrictions and/or prohibit timers may be applicable on a change delta value level (e.g., WTRU cannot jump from configuration value x to delta Y, but the WTRU can jump from value x to value z, where value z is for example less than delta Y). The WTRU may start the prohibit timer if the change value is larger than a threshold. The WTRU may change (e.g., autonomously change) the value without request, for example, when the change is less than another threshold.

In examples, the network may broadcast a range of values that are applicable to a parameter. The WTRU may use the range of values to change the parameter.

One or more conditions described herein may trigger WTRU autonomous change of a parameter. For a given parameter, the WTRU may change some values autonomously without informing the network, the WTRU may change some values and inform the network, and the WTRU may request the network before changing some values. For example, the possible non-default parameter values can be grouped into a first set/range of values that the WTRU can change from the default value without the need to inform the network, a second set/range of values towards which a change is allowed but the WTRU needs to inform the network, and a third set/range of values where the WTRU must request the network before changing the value to a value in this range, etc. Similar behavior can be specified in terms of delta values to apply to the default parameter value. For example, if the parameter can take a numeric value, a delta of +/−n1 from the default value maybe allowed without informing the network, a delta of +/−n2 from the default value may be allowed but the WTRU may inform the network about the change, but the WTRU may request the network to change the value by more than +/−n2 from the default value.

For a given parameter, the WTRU may be configured to apply autonomous change of a parameter value to a non-default value (e.g., without informing the network) as long as the KPI metric associated with that parameter fulfilling a first set of conditions/thresholds. The WTRU may inform the network after the change when the KPI fulfills a second set of conditions/thresholds. The WTRU cannot change the parameter value autonomously and must request the change from the network if the KPI fulfills a third set of conditions/thresholds.

The WTRU may change the configured value not more than a max change delta, if configured. The WTRU may be configured to make one step change from one value to the next or previous value (e.g., max delta change, if configured). The WTRU may be configured to not jump by more than one step change unless the WTRU sends a request to the network.

The WTRU may be configured to change the parameter value as a function of a KPI change (e.g., to be stricter), for example, upon experiencing any failure, meeting any of the conditions discussed herein, and/or upon not improving a KPI. For example, the WTRU may restrict change (e.g., by y % or a max delta) if KPIs have not improved more than x % margin.

Amongst a plurality of values, the WTRU may select a non-default value of the plurality of values with the highest priority. Amongst a plurality of values, the WTRU may select the non-default value of the plurality of values that maximizes a KPI associated with the configuration parameter.

The WTRU may send a report based on determining that a parameter value has changed. Upon autonomously changing the value for a configured parameter, the WTRU may provide feedback confirming a change of a parameter within a range/selection of a non-default value (e.g., depending on parameter or value change with respect to a default value). The selected value (e.g., in the feedback) may be appended to a next message that the WTRU sends. The feedback may be sent via UCI, MAC CE, generic UL RRC reconfiguration message, and/or UAI. For example, the feedback may be multiplexed on an associated transmission. The feedback may include a delta value. The delta value may represent an amount of change between a last used value or default value and the selected value.

If the WTRU has changed to a non-default value (e.g., autonomously), the WTRU may provide feedback at a later time (e.g., after the network signals a configuration change (RCE) that is not aligned with the WTRU change and/or after the WTRU receives a request from the network about feeding back the selected value).

Whether the WTRU transmits the feedback about the change may be parameter dependent and/or scenario dependent, for example, to ensure synchronization with the network.

The WTRU may provide/report one or more associated KPIs (e.g., QoE level/PER, UE state, memory state, etc.) associated with the changed parameter or the value change delta, for example, upon autonomously changing the value for a configured parameter.

The WTRU may monitor DL (re)-configuration signalling (e.g., an RCE) and/or fallback signalling after a WTRU autonomous change to a non-default value, for example, upon requesting and/or changing a parameter value to a non-default value and/or a value outside of the configured range.

A reporting type and/or whether to report may be scenario dependent and/or parameter dependent. The WTRU may report a change to the network if one or more condition for reporting a change of configuration to a non-default value has been met, for example, upon changing a configured value/selecting a non-default value. The WTRU may report the change (e.g., the WTRU has selected a non-default value/changed the configuration, the WTRU has selected non-default configuration value, and/or the change delta). The WTRU may report one or more associated KPIs (e.g., QoE level/PER, UE state, memory state, etc.) that led to a change decision.

Feedback may confirm a change of a parameter within a range/selection of a non-default value, and conditions to do so (e.g., depending on parameter or value change with respect to default). The feedback may be on UCI, MAC CE, generic UL RRC reconfig message, or UAI. For example, the feedback may be multiplexed on an associated transmission. The feedback may include a delta value (e.g., a delta from the default value, a delta from the previous value that was changed, etc.). The feedback may be parameter dependent, for example, to ensure synchronization with the network. The network may indicate a range, and the WTRU may use the range to change the parameter.

Timing of report/change may be provided. In some cases, there may be no need to inform the network immediately about the change of the parameters. In other cases, the WTRU may inform (e.g., need to inform) the network immediately. For example, the WTRU may be configured with a prohibit timer. The WTRU, after sending one such indication, may refrain from sending a subsequent indication before the prohibit timer expires. The WTRU may aggregate a plurality of (e.g., all) the parameters that has changed in that duration in one report.

The WTRU may be configured to report a change of one or more parameter values upon (e.g., only upon) a request from the network. For example, the network may send a request to the WTRU to send any parameters that the WTRU has changed since the last time the WTRU has sent a report. In examples, the request may explicitly indicate the parameters of interest and the WTRU may respond regarding (e.g., only regarding) those parameters.

The WTRU may be configured to report a change of one or more parameter values upon some event (e.g., upon sending measurement reports, upon mobility, upon recovery from failure, etc.). The WTRU may also provide reporting of a failure to the network (e.g., when a parameter value is changed for failure timers). The WTRU may report a packet/SDU discard (e.g., when a discard timer value is changed). The WTRU may report a WTRU state (e.g., such as limited memory, power saving, etc.), for example, when the WTRU parameter value change is triggered by a WTRU state change. The WTRU may report a QoE level and/or an associated PER/remaining time, for example, when the value is changed to due a latency budget, potential discard, and/or an interaction with the application layer.

The WTRU may monitor for the reception of PDCCH, RRC reconfiguration, an RCE, and/or a fallback indication after a WTRU autonomous change of a parameter value or after the WTRU reports a change.

Different UL signalling may be used to indicate to the network that the WTRU has autonomously changed the value of one or more parameters. The UL signaling can be RRC signaling (e.g., enhanced WTRU Assistance Information, UAI message, or a new UL RRC reconfiguration message, etc.) a MAC CE, a UCI multiplexed on PUSCH, etc.

The WTRU may indicate a change using UAI, for example, if there are a small amount (e.g., only a handful) of parameters that the WTRU is configured change autonomously/dynamically. The WTRU may use UAI or similar signaling to notify the network that a value has been changed. The WTRU may send a UAI or similar message that indicates the parameter being changed and/or the new value (e.g., or an index to the possible value set, or it could be a Boolean flag, indicating going up or down the list of possible values, for example, if we allow the WTRU a one step change (e.g., only a one step change) at a time).

The WTRU may indicate a change using delta configuration reporting. For example, the WTRU may use a new UL RRC message (e.g., similar to the DL RRC message) that indicates the changed parameters and/or their values (e.g., similar to the way a DL delta configuration is used in the UL, but this time for information the network about the changes). If one step change (e.g., only one step change) is allowed, then a plurality of (e.g., all) the parameters in this delta configuration may be of boolean type, instead of the data type of the corresponding IE in the reference configuration, for example, because an up/down indication may indicate to go up/down the index of values.

The WTRU may be provided with a reference/baseline configuration (e.g., including the non-dynamic parameters, and the default values for the dynamic ones, etc.) and a plurality of delta configurations that have different combination values of the dynamic parameters. Each of the plurality of delta configurations may have an index. When the WTRU decides to change, the WTRU may send the index of a chosen delta to the network. The WTRU may send the index either via RRC, an uplink RCE, or a MAC CE. In some cases (e.g., scenario dependent or parameter dependent), the WTRU may receive an ACK or an RCE (e.g., DL reconfiguration complete message) indicating whether the changes are accepted.

### UE Mitigation Actions Associated With a Parameter Change

The WTRU may perform one or more mitigation action if the value is changed to avoid a failure (e.g., RLF, beam failure), for example, if an associated KPI falls below a threshold. A mitigation action may include one or more of the following: cell reselection, bwp change, a bwp activation/deactivation, execution of a mobility command, SCell change, SCG reselection, initiation of a random access or an SR to notify the network (e.g., in a MAC CE/RCE), transmission of a wake-up request, an activation/deactivation of a configured grant or an SPS resource, and or monitoring additional channel measurement resources (e.g., RRM, BFD, or CSI resources). The selected mitigation action may depend on the parameter change, the selected value, and/or the change delta.

A WTRU may fall back to a default/previously configured value. The WTRU may fall back to the previously configured value or the default value after expiry of a fall back to default value time, upon reception of a fallback indication from the network (e.g., in a MAC CE, RCE, or an indication by DCI), upon reception of an RCE that doesn't not include a selected value, and/or upon meeting one or more conditions for fall back to default configuration value.

Upon falling back, the WTRU may indicate to the network that the WTRU has reverted to the previously configured value or the default value. The UE may fallback to the default value/previous value if a condition has been met or is no longer met. For example, if a KPI associated with a given parameter falls below/above a threshold or is within a range, the WTRU may signal that the WTRU is falling back to the default/previous value. The WTRU may select a value or fallback to a default value based on a signalled KPI in the downlink (e.g., based on congestion, NW related condition).

The WTRU may receive an indication from the network to fallback to a default configuration or switch on/off to range-based operation. The indication may be provided by: a group common indication (e.g., an indication by DCI), an RCE message, an RRC message, and/or a parameter specific or DRB specific indication.

The indication from the network may turn off WTRU autonomous parameter value change operation or prohibit WTRU autonomous parameter value change operation for a configured period (e.g., possibly for a given parameter or for a plurality of (e.g., all) parameters configured for WTRU autonomous value selection. A bit in MIB/SIB signalling may be used for fallback. For example, the UE falls back to the default value or turns off range based operation when the value is flagged.

### Conditions for Fallback to Default Configuration Value

A condition to fallback to a default value or the previously configured value for a parameter may depend on the parameter type, the amount of value change, and/or the scenario. The condition to fallback to a default value or the previously configured value for a parameter may include one or more of the following. The condition to fallback to a default value or the previously configured value for a parameter may include a missing a confirmation from the NW about a request to change. The condition to fallback to a default value or the previously configured value for a parameter may include the NW signalling a configuration change that is not aligned with the WTRU change. The condition to fallback to a default value or the previously configured value for a parameter may include no reception of a grant/ACK in response to a change request for a parameter value change. The WTRU may change the value conditioned on transmitting a request to change a configured value and/or receiving a command from the network granting/acknowledging the request (e.g., an RCE) for a subset of parameters, otherwise falls back to the default/previously configured value.

The condition to fallback to a default value or the previously configured value for a parameter may include no reception of DL signaling or an RCE, e.g., indicating a specific KPI, NW/cell congestion, and/or to allow the WTRU to suggest a different configuration or autonomously change the configuration value. The condition to fallback to a default value or the previously configured value for a parameter may include an observed KPI (e.g., PER ratio, FEC ratio, etc.). The WTRU may fallback if the observed KPI (e.g., associated with the parameter) is within a range, lower, or larger than a threshold. For example, the WTRU may fallback to default values upon experiencing any failure or meeting any of the conditions or upon not improving an associated KPI, e.g., by more than a configured margin. The condition to fallback to a default value or the previously configured value for a parameter may include a remaining time associated with a packet/SDU. The WTRU may fallback if the remaining time is larger than a threshold or within a given range. The condition to fallback to a default value or the previously configured value for a parameter may include a presence of dependent data for transmission. For example, in multi-modality, value 1 may be used when dependent data x from associated flow xx is available for transmission/transmitted/received. Value 2 may be used otherwise (e.g., an LCH priority). In PDU sets, value 1 may be used when PDU x from associated PDU set is available for transmission/transmitted/received. Value 2 may be used otherwise.

The condition to fallback to a default value or the previously configured value for a parameter may include satisfying a CP event (e.g., CHO event met, failure event triggered, etc.). The CP event may include RLF, beam failure, and/or the WTRU not being able to decode the network. The condition to fallback to a default value or the previously configured value for a parameter may include a WTRU state, e.g., WTRU memory headroom, WTRU power consumption/savings state, WTRU overheating state, a CPU consumption state, etc. The condition to fallback to a default value or the previously configured value for a parameter may include interactions with the application/API (e.g., such as reception of an up/down QoE level). The condition to fallback to a default value or the previously configured value for a parameter may include channel related conditions and/or measurements. The condition to fallback to a default value or the previously configured value for a parameter may include a subscription based condition or policy-based conditions, dedicated by the operator. The condition to fallback to a default value or the previously configured value for a parameter may include KPI (e.g., such as BLER, PER, tput) improving by x margin within a window since change. The condition to fallback to a default value or the previously configured value for a parameter may include as a function of the WTRU being in a given WTRU state. The condition to fallback to a default value or the previously configured value for a parameter may include one or more other conditions described herein.

The WTRU may adapt one or more configured values for various user plane timer, parameters, variables, and/or counters per the methods described herein.

The one or more configured values that the WTRU may change include LCP parameters. The LCP parameters may include PBR or BSD in LCP. The WTRU may be configured with a PBR and/or BSD range. The WTRU may boost PBR and/or extend BSD within range (for a given grant), for example in order to fit an SDU without segmentation and/or transmit high priority/low remaining time packets. The LCP parameters may include LCH LCP priority adaptation within a range, possibly based on a condition. The LCP parameters may include whether to apply a LCH restriction.

The WTRU may be configured with a plurality of logical channel prioritization parameters per data flow (e.g., LCH), including a traffic shaping parameter: prioritized bit rate (PBR_self-fulfilling prophecy), priority, and bucket size duration (BSD). One value may be a default value and other values may be non-default values. The WTRU may use a non-default value as a function of meeting one or more conditions, meeting a KPI (e.g., within a range, above or below a threshold), and/or as a function of an AI/ML process at the WTRU.

The WTRU may be configured with conditional LCP LCH selection restrictions. The WTRU may apply or relax a restriction as a function of meeting one or more conditions, meeting a KPI (e.g., within a range, above or below a threshold), and/or as a function of an AI/ML process at the WTRU.

The WTRU may upgrade or downgrade the priority, PBR or BSD, and/or apply or relax an LCP LCH selection restriction, for example, if one or more conditions for using a non-default value are met. The one or more conditions for using a non-default value are met may include the WTRU avoiding segmentation for an SDU from the LCH. The one or more conditions for using a non-default value are met may include the WTRU being able to transmit data from the flow before the expiry of a discard timer (e.g., remaining timer is less than a configured threshold). The one or more conditions for using a non-default value are met may include the WTRU being able to transmit data (e.g., of higher priority>a threshold—(than other data), possibly before the expiry of an application layer timer (e.g., a survival time timer). The one or more conditions for using a non-default value are met may include the WTRU being able to increase throughput and/or a KPI associated with a data flow beyond a configured minimum threshold, for example, by using a non default value. The one or more conditions for using a non-default value are met may include buffered user plane data having a priority that is greater than a threshold. The one or more conditions for using a non-default value are met may include buffered user plane data volume being less than a threshold. The one or more conditions for using a non-default value are met may include a time elapsed since SDU arrival (e.g., at the WTRU memory or at the PDCP buffer) having a remaining time before expiry that is less than a threshold. The one or more conditions for using a non-default value are met may include load/network congestion conditions. The WTRU may transmit data with a non-default value if congestion is not determined/detected. The WTRU may determine the congestion level from network signaling (e.g., broadcast or dedicated-MAC or DCI-signaling). The WTRU may downgrade a traffic shaping parameter, for example, if the WTRU or the network is in a congestion state or a NES state. The one or more conditions for using a non-default value are met may include a determined NES state. The one or more conditions for using a non-default value are met may include a WTRU power saving state. The one or more conditions for using a non-default value are met may include a WTRU CPU load or processing state. The WTRU may transmit data with a non-default traffic shaping value in a subset of WTRU states (e.g., while the WTRU is not overheating, available memory>threshold, or CPU consumption is less than a threshold). The one or more conditions for using a non-default value are met may include a measured channel condition being greater or less than a configured threshold. For example, data may be transmitted with a non-default traffic shaping value if the power headroom is above or below a given threshold. Data may be transmitted with a non-default traffic shaping parameter when the WTRU measures RSRP or a metric related to UL and/or DL coverage being better than a configured threshold. The one or more conditions for using a non-default value are met may include the PBR value and/or Bj value associated with a DP LCH or logical buffer being greater or less than a threshold. The one or more conditions for using a non-default value are met may include a condition for WTRU autonomous value selection being met as described herein.

The one or more configured values that the WTRU may change include QoS. Adaptation of QoE parameters (e.g., QoS marking, QoS flow to DRB mapping) from a range of possibilities may be performed based on a condition (e.g., if one of the conditions more conditions for using a non-default value/WTRU autonomous value selection has been met). The one or more configured values that the WTRU may change include retransmission timers (e.g., CG retx timer, tReassembly). The WTRU may use a shorter CG timer if the WTRU determines that the network has not decoded the TB (re)-transmission, has not achieved an acceptable level of energy accumulation (from repetition or retransmissions), and/or as a function of the data that is multiplexed in the TB. For example, the WTRU may use a shorter CG retx timer if multiplexed data includes data from a given LCH/flow of high priority/reliability (e.g., SRB data, UP data of high priority>threshold, data of low remaining time to discard).

The one or more configured values that the WTRU may change include discard timers (e.g., PDCP discard timer, tReordering). The WTRU may discard sooner if memory is limited and/or a WTRU state changes. The WTRU may use a shorter timer value if the amount of buffered data (e.g., for all or subset of data flows) is above a threshold. The one or more configured values that the WTRU may change include HARQ process timers (e.g., CG timer, time to provide HARQ FB “k1”). The WTRU may use a shorter CG timer (e.g., to flush the HARQ process buffer for a configured grant) if the WTRU determines that the network has decoded the TB, achieved an acceptable level of energy accumulation (from repetition or retransmissions), and/or as a function of the data that is multiplexed in the TB. For example, the WTRU may use a larger or shorter CG timer if multiplexed data includes data from a given LCH/flow of high priority/reliability (e.g., SRB data, UP data of high priority>threshold, data of low remaining time to discard). The WTRU may set the CG timer to the value of the value of the discard timer (e.g., time remaining until PDCP discards the SDU), for example, if the remaining time is below a threshold. The WTRU may stop the CG timer, flush the HARQ process, and/or flip the associated NDI bit upon discarding an SDU that was transmitted on the associated HARQ process (e.g., free the HARQ process to be used for new data transmission). If the CG timer is still running and the PDCP discard timer has expired or is about to expire, the WTRU may restart, extend the PDCP discard timer, or add an offset to its current value, for example, to match the remaining time before the CG timer expires. Restarting, extending, and/or adding an offset to the PDCP discard timer may avoid a premature discard, for example, until the pending transmission goes through in lower layers. The WTRU may restart the PDCP discard timer with a value that matches the CG timer or the remaining time in the CG timer, possibly if the associated HARQ process includes data of a given priority/importance/QoS class and/or remaining timer less than a threshold. The WTRU may stop the CG timer, flush the HARQ process, and/or flip the associated NDI bit upon reception of a discard indication (e.g., a MAC CE indicating discarding data from a data flow/RB/LCH that is multiplexed on the HARQ process associated with the configured grant timer and the HARQ process includes data from such data flow/RB/LCH). The WTRU may trigger a (re)-transmission (e.g., an ARQ/new retransmission or a HARQ retransmission) that includes SDUs that were discarded (or about to be discarded due to the remaining time being less than a threshold), where the WTRU may select the same HARQ process on which the data was discarded, but for which the CG timer is still ongoing or is stopped due to a discard timer expiring. Such can be applicable If the CG timer is still running and the PDCP discard timer has expired or is about to expire. The WTRU may construct an ARQ retransmission by creating a TB that matches the TB on the ongoing HARQ process for which the CG timer is still running/was stopped and transmit such TB on the same HARQ process, for example, even though upper layers may have discarded the SDUs. This may allow the pending transmission to complete even though a discard has happened at higher layers.

The one or more configured values that the WTRU may change include RA timers (e.g., a backoff timer). The WTRU may be configured or indicated a plurality of backoff times, a range of backoff values, and/or a single backoff which is used as a maximum backoff. The WTRU may determine a shorter backoff timer value to select, for example, based on the WTRU access type (e.g., feature indication, WTRU capability, access priority, slice used for network access, WTRU subscription type, etc.). The WTRU may use a non-default value for the backoff, for example, rather than selecting at random a value between 0 and the maximum value indicated. A lower priority WTRU or access type may use a higher range for the selection of the backoff value, e.g., between MaxBackoff/2 and Maxbackoff. A higher priority WTRU or access type may use a lower range for the selection of the backoff value, e.g., between 0 and MaxBackoff/2.

The one or more configured values that the WTRU may change include timers related to RRC connection setup/resume/establishment, e.g.: T300 (e.g., used to control how long the WTRU waits for an RRC setup message after sending an RRC Setup request), T301 (e.g., used to control how long the WTRU waits for an RRC Re-establishment message after the sending the RRC Reestablishment request message before going to IDLE state), T319 (e.g., used to control how long the UE waits for an RRC Resume message after sending an RRC Resume request message), etc. The one or more configured values that the WTRU may change include timers to control handover, e.g., T304. The timers to control handover may be used to control how long the WTRU waits, after the reception of a handover command, for the random access to the target to be completed (e.g., before considering the handover has failed). The one or more configured values that the WTRU may change include timers and counters to control radio link failure, for example, N310: a number of consecutive out of sync indication that is received from the PHY layer to indicate radio link problem is being experienced; T310: a timer that is started when radio link problem is detected (e.g., based on N310); and/or N311: the number of consecutive in sync indications that is received from the PHY layer to indicate radio link has recovered (e.g., if T310 expires before N311 indications are received, radio link failure is detected). The one or more configured values that the WTRU may change include timers/counters related to beam failure detection and recovery, e.g.: a beamFailureInstanceMaxCount: the maximum number of beam failures that the UE can tolerate before triggering the recovery procedure and/or a beamFailureDetectionTimer: the maximum time duration for monitoring and detecting beam failures.

The one or more configured values that the WTRU may change include PHY parameters. In examples, the set of non-default values and/or range can be applicable to physical layer parameters, including but not limited to: Tx power, MIMO parameters, MCS value or code rate, WTRU and common signal and channel transmission periods, SRS transmission parameters and frequency/periodicity, CSI measurements and reporting frequency and periodicity, and/or uplink transmit beam related parameters (e.g., beamwidth, number of beams, QCL associations, and (de)-activation statuses). The range of non-default values may be configured by higher layers, provided by MAC CE signalling, provided by DCI signalling/indication, and/or determined from a property of the scheduling and/or physical layer resource. In examples, the WTRU may assume value 1 or range 1 is applicable in resource set 1/bwp1, value 2 or range 2 is applicable in resource set 1/bwp2, and so on. The association may be configured or indicated. In examples, the WTRU may use value 1 or range 1 for CSI reporting depending on the antenna port/element configuration that is in use, value 2 or range 2 for CSI reporting if the antenna port/element configuration 2 is used/activated, and so on.

The WTRU may select parameters as a function of packet classification. The WTRU may use a procedure to classify UL data units (e.g., packets within a data flow, SDUs, PDUs within a PDU set) on a dynamic basis. A data unit may be assigned with a QoS Class if the data unit meets one or more conditions. The WTRU may determine a value to use for a configuration parameter as a function of the QoS class associated with the packet, e.g., if the packet or an associated performance KIP is associated with a configuration parameter. For a given QoS class, the WTRU may be configured with a plurality of QoS RAN non-default treatment profiles and/or QoE levels, and the WTRU may select amongst them as a function of the QoS class, UE-side LCM, and/or the rules described herein.

When a condition for QoS classification has been met, the WTRU may assign a certain QoS class value to a given data unit, which may or may not be the default QoS class. The WTRU may be configured with a default QoS class, which may be preconfigured semi-statically for the whole data flow. If no special classification conditions are met, the WTRU may classify a data unit from such flow with the configured default QoS class for the data flow. The WTRU may be configured or predefined with one or more non-default QoS class(es), where there is a mapping between a given QoS class and a condition for QoS classification. When the condition for QoS classification has been met, the WTRU may associate the data unit with the non-default QoS class.

A condition for QoS classification may include one or more of the following. A condition for QoS classification may include packet priority, for example, based on the possibility of transmission/inclusion of buffered data from a subset of PDUs within a PDU set, where such PDUs can be configured or predetermined to be of higher priority, a lower delay bound, or high QoS treatment profile compared to other PDUs within the set. If the data unit is associated with a higher priority, the WTRU may associate the data unit with a given QoS class. If the data unit is associated with a lower priority, the WTRU may associate data unit with another QoS class.

A condition for QoS classification may include packet importance, for example, based on the possibility of transmission/inclusion of buffered data from a subset of PDUs within a PDU set. Such PDUs may be configured or predetermined to be of higher importance compared to other PDUs within the set. Importance may include a value obtained from an indication from the core network packet profile, the application interface, and/or from the service characteristics (e.g., the period of the packet or the type of packet associated with it). If the data unit is of higher importance, the WTRU may associate the data unit with a given QoS class. If the data unit is of lower importance, the WTRU may associate the data unit with another QoS class.

A condition for QoS classification may include a packet delay budget, for example, a possibility of transmission/inclusion of buffered data from a subset of PDUs within a PDU set. The remaining time until the delay budget for the PDU or the underlying application may be less than a threshold. If the delay budget is less than the threshold, the WTRU may associate the data unit with a given QoS class. A condition for QoS classification may include a data type. For example, a condition may be met as a function of inclusion of data from a given type, e.g., AI/ML, XR, sensing, volumetric video. For example, for a data unit including AL/ML data, the WTRU may associate the data unit with a given QoS class. For a data unit including sensing data, the UE may associate the data unit with another QoS class.

Reception of an indication from the application or the RAN-application interface (API): the application may indicate that for a given data unit, a differentiated QoS class is to be associated. The Indication may provide a given QoS class or an identifier associated with it. The UE may be configured with a given non-default QoS class to apply to a data unit once an indication/flag is received from the API for such data unit. For example, upon reception of an indication from higher layers (e.g., from application) indicating that such packet needs to be prioritized ahead of other buffered packets in the queue for such data flow, the UE may associate a different (e.g., non default) QoS class to the data unit.

A condition for QoS classification may include reception of an indication from the network overriding the configured default QoS class for one or more data flows. The indication may include a given QoS class to apply, possibly for a period of time. Such indication may be determined as a function of a property of the scheduling information (e.g., in the DCI) or an indication by DCI.

A condition for QoS classification may include reception of an indication for a given grant. A DCI may signal a given QoS class, for such QoS class, data (e.g., only data) associated with such class can be multiplexed. Additionally or alternatively, the WTRU may multiplex data regularly on the grant then treat the whole TB as data with the signaled QoS class (e.g., in lower layers). Such indication may be determined as a function of a property of the scheduling information (e.g., in the DCI) or an indication by DCI.

A condition for QoS classification may include data from a gating data set. The WTRU may associate a given non-default QoS class to a gating data unit.

A condition for QoS classification may include as a function of dependent data or data set. For a data unit that other units depend on (e.g., an FEC source packet, a video defining frame—e.g., I frame-, a gating data unit) a non-default (e.g., prioritized) QoS class may be assigned. For dependent, duplicated, and/or redundant data units, a different QoS class may be assigned (e.g., a default QoS class associated with the flow). A condition for QoS classification may include as a function of systematic PDU within a set, for example, possibility of transmission/inclusion of buffered data of a systematic frame/data unit within a data flow (e.g., source data units that are encoded, systematic video frames, etc.).

A condition for QoS classification may include satisfying one or more control plane events, for example, satisfying one or more mobility event condition and/or satisfying a conditional handover condition to one or more handover candidate. For example, upon satisfying a mobility, an RLM, a beam failure, or an RLF, the WTRU may associate a different QoS class with a data unit, possibly for a period of time associated with the CP event.

A condition for QoS classification may include sensing an object or determining an outcome from a sensing or positioning procedure. For example, sending data may be configured or pre-associated with a given QoS class. Upon detection of an object as a function of sensing or a spatial computing service as an outcome of sensing, the WTRU may select a certain QoS class (e.g., non default or configured QoS class). A condition for QoS classification may include dropping or adding one or more data flows. Upon adding or dropping or more service or a data flow (e.g., from a multi-modal service or session), the WTRU may change the QoS class associated with the remaining data flow or dependent data flow.

A condition for QoS classification may include synchronization between data flows. If synchronization between data flows is configured or indicated from the application or the core network, the WTRU may associate one QoS class for data units when a dependent data flow is synchronized and another QoS class when the data flow is not synchronized or within a period of miss-synchronization (e.g., a remaining synch time is larger or lower than a threshold). If a common identifier is used (e.g., signaled from the application or the core network) to associate two or flows, the WTRU may use the same QoS class for data units of the two or more data flows. Once dissociated, the WTRU may revert to the default QoS classes configure for each data flow individually.

A condition for QoS classification may include dropping or adding one or more dependent data types. If the WTRU is configured to need X out of Y data units to decode an overall packet (e.g., an FEC encoded packet, a source video frame, etc.), the WTRU may select a given QoS class when X out Y have been successfully decoded. The WTRU may associate a different QoS class when X out of Y have not been successfully decoded, if X′ out of Y units have been received, and/or if X″ units have been not acknowledged but received.

A condition for QoS classification may include satisfying one or more events from the transport layer protocol (e.g., generating TCP ACK, transmission of an out of order packet within a transport protocol session/connection, reading a specific value from the header of the transport layer protocol for a given packet). When such condition has been met, the WTRU may associate the associated data unit of the related RAN data flow with a given QoS class. The WTRU may be able to determine or more properties of the transport layer protocol from a relay on top of the RAN protocol stack, for example, which is used to de-cypher and decrypt the transport layer header and/or content if encrypted.

A condition for QoS classification may include measuring a channel condition below or above a given threshold or measuring a change in the channel conditions below or above a given threshold. When such condition has been met, the WTRU may associate a data unit with a given QoS class. A condition for QoS classification may include as a function of an LCM output at the WTRU side. A condition for QoS classification may include as a function of whether the data unit is transmitted initially or retransmitted (e.g., or as a function of the retransmission number). A condition for QoS classification may include as a function of the energy saving state of the network (e.g., which may be indicated to the WTRU) or the power saving state of the WTRU (e.g., whether DRX is used).

A condition may be bound for a period of time, e.g., once satisfied, the condition may be considered satisfied until the period of time (e.g., configured or predetermined) has elapsed. When the condition is met during the period of time, a differentiated QoS class may apply to the data unit. Once the period expires, the data unit may be associated with a default QoS class or a reverted QoS class that was assigned before the condition was met. A condition may be bound to a subset of data flows (e.g., a QoS flow, data unit set, a DRB, LCH, LCG, PDU set, etc.). Once satisfied, the WTRU may determine that the condition is applied for (e.g., only for) the applicable set of data flows (e.g., which may be configured by higher layer signalling) and/or the associated QoS class is applied for the data unit. A condition may be bound to a subset of data types (e.g., control data, user data, system data, intelligence data (AI/ML), positioning data, and/or sensing data). Once satisfied, the WTRU may determine that the condition is applied for (e.g., only for) the applicable set of data type (e.g., which may be configured by higher layer signalling) and the associated QoS class is applied for the data unit. A condition may be bound to a subset of device capability. A condition may be bound to a subset of uplink grants, grant types (e.g., dynamic vs. semi-static/configured grants), a subset of grant indication properties, and/or a property of the grant scheduling indication (e.g., the DCI indication or as a function of the DCI scheduling parameters).

A WTRU may be configured with a subset of configuration parameters. For example, the WTRU may receive configuration information from the network. The configuration information may indicate one or more of an applicability range for each of the plurality of configuration parameters or a set of default and non-default values for each of the plurality of configuration parameters. Each of the plurality of configuration parameters may be associated with a respective information element, may be used to configure the WTRU for operation or communication with the network, and/or may comprise any combination of a timer or a counter. For example, each of the plurality of configuration parameters may be any value in an IE provided via RRC that can hold one of many values.

For example, each configuration parameter may be configured with an applicability range. The applicability range may include a plurality of values and/or a set of default and non-default values, including one or more of the following. Range may be configured as s single value configuration+/−a delta range, or as a min/max range. The WTRU may be provided with a default value (e.g., t1), and a plurality of other non-default values (e.g., timer x={t2, t3, t4, . . . , tn}). Each parameter may be configured with a max change delta. The max change delta may represent the maximum value the WTRU can change a respective parameter from the default value at a given time. Each parameter may be configured with a reporting delta. The reporting delta may represent a change delta relative to the configured/default value at which the WTRU reports to the network the change of value and/or selected value. Each parameter may be configured with a request a change delta. The WTRU may request to change a configured value if the desired value is more than the request a change delta from the configured/default value. Each parameter may be configured with a KPI reporting metric. The KPI metric may be reported periodically once a non-default value is selected/requested or a KPI is used to condition the parameter value change.

The WTRU may determine that one or more conditions are met for changing one or more values of a variables values. The one or more conditions may include reception of a grant or acknowledgment (ACK), an observed KPI is within a predetermined range, the observed KPI is greater or less than a predetermined KPI threshold, a remaining time associated with a packet is less than a threshold, a control plane (CP) event has been satisfied, a measured channel condition is within a predetermined range, a measured channel condition is greater than a predetermined threshold, and/or the measured channel condition is less than a predetermined threshold. The WTRU may perform one or more of the following.

The WTRU may request to change a configured value to a non-default value (e.g., a value within the configured range), for example, if one or more conditions are met for requesting a configuration change to a non-default value. For example, the WTRU may send a request to change the configured value of the first configuration parameter from the first configured value to the second configured value (e.g., prior to changing the configured value of the first configuration parameter). The WTRU may report a KPI associated with the requested parameter value change. The WTRU may request a change beyond a configured non-default value (e.g., out of range). The WTRU may select and/or change a configured value to a non-default value (e.g., a value within the configured range), for example, if one or more conditions are met for WTRU autonomous change of configuration to a non-default value. The WTRU may change the configured value by an amount that is less than a max change delta. The WTRU may select a non-default value based on a WTRU-sided model (e.g., AIML based model, statistical model, etc.). The WTRU may start a WTRU autonomous selection prohibit timer, for example, to limit such action while the timer is running. The WTRU may increment a counter associated with the parameter being changed (e.g., the WTRU may be configured to make a maximum number of parameter changes, for example, within a given time duration, etc.). The WTRU may start a fallback to default value timer. The selection and/or changing of a configured value to a non-default may be conditioned on transmitting a request to change a configured value and/or receiving a command from the network granting and/or acknowledging the request (e.g., an RCE) for one or more (e.g., a subset of) parameters.

Upon changing a configured value/selecting a non-default value, the WTRU may report the change to the network, for example, if one or more conditions are met for reporting a change of configuration to a non-default value. The WTRU may report the change. For example, the WTRU may report a selected non-default value/changed the configuration, the selected non-default configuration value, and/or the change delta. The WTRU may report one or more associated KPIs (e.g., such as QoE level/PER, UE state, memory state, etc.).

The WTRU may revert (e.g., fall or change) back to a previously configured value and/or the default value after expiry of the fallback to default value time duration, for example, upon reception of a fallback indication from the network (e.g., in a MAC CE, RCE, or an indication by DCI) and/or upon meeting one or more conditions for fallback to a default configuration value. The WTRU may indicate to the network that the WTRU has reverted (e.g., changed back) to the previously configured value and/or the default value. The indication from the network may turn off a WTRU autonomous parameter value change operation and/or prohibit the WTRU autonomous parameter value change operation for a configured period.

The WTRU may be configured with a plurality of logical channel prioritization parameters per data flow (e.g., LCH). The plurality of logical channel prioritization parameters may include a traffic shaping parameter (e.g., a prioritized bit rate (PBR_self-fulfilling prophecy), a priority, and/or a bucket size duration (BSD)). One value may be a default value and others may be non-default values. The WTRU may use a non-default value as a function of meeting one or more conditions, meeting a KPI (e.g., within a range, above or below a threshold), and/or as a function of an AI/ML process at the WTRU.

The WTRU may be configured with conditional LCP LCH selection restrictions. The WTRU may apply and/or relax a restriction as a function of meeting one or more conditions, meeting a KPI (e.g., within a range, above or below a threshold), and/or as a function of an AI/ML process at the WTRU.

The WTRU may upgrade or downgrade the priority, PBR or BSD, and/or apply or relax an LCP LCH selection restriction if one or more conditions are met. The one or more conditions may include whether the WTRU avoids segmentation for an SDU from the LCH. The one or more conditions may include whether the WTRU is able to transmit data from the flow before the expiry of a discard timer (e.g., remaining timer is less than a configured threshold). The one or more conditions may include whether the WTRU is able is able to transmit data (e.g., of higher priority>a threshold—(than other data)), possibly before the expiry of an application layer timer (e.g., a survival time timer). The one or more conditions may include whether the WTRU is able to increase throughput or a KPI associated with a data flow beyond a configured min threshold, by using a non default value.

1. A wireless transmit/receive unit (WTRU) comprising:
a memory and a processor, wherein the processor is configured to:
receive configuration information from a network, wherein the configuration information associated with a plurality of configuration parameters, and wherein the configuration information indicates one or more of an applicability range for each of the plurality of configuration parameters or a set of default and non-default values for each of the plurality of configuration parameters, wherein each of the plurality of configuration parameters is associated with a respective information element and is used to configure the WTRU for operation or communication with the network;
determine that one or more conditions associated with a first configuration parameter of the plurality of configuration parameters has been met;
change a configured value of the first configuration parameter from a first configured value to a second configured value based on the one or more conditions being met, wherein the second configured value is one or more of within the applicability range for the first configuration parameter or a non-default value for the first configuration parameter;
send a report to the network that indicates the second configured value of the first configuration parameter; and
revert back to the first configured value based on one or more of expiration of a fallback to default value time duration, reception of a first fallback indication from the network, or a fallback to default value condition being met.

2. The WTRU of claim 1, wherein processor is further configured to send, to the network, a request to change the configured value of the first configuration parameter from the first configured value to the second configured value prior to changing the configured value of the first configuration parameter.

3. The WTRU of claim 2, wherein the first configured value is a default value and the second configured value is a non-default value.

4. The WTRU of claim 1, wherein the one or more conditions comprise reception of a grant or acknowledgment (ACK), an observed key performance indicator (KPI) is within a predetermined range, the observed KPI is greater or less than a predetermined KPI threshold, a remaining time associated with a packet is less than a threshold, a control plane (CP) event has been satisfied, a measured channel condition is within a predetermined range, a measured channel condition is greater than a predetermined threshold, or the measured channel condition is less than a predetermined threshold.

5. The WTRU of claim 1, wherein the configuration information indicates one or more of a max change delta, a reporting delta, a request a change delta, or a key performance indicator (KPI) metric.

6. The WTRU of claim 5, wherein the second configured value is less than the max change delta from the first configured value.

7. The WTRU of claim 1, wherein each of the plurality of configuration parameters comprises any combination of a timer or a counter.

8. The WTRU of claim 1, wherein the processor is further configured to send a second fallback indication to the network that indicates that the WTRU has reverted to the first configured value.

9. The WTRU of claim 1, wherein the first configured value is a previously configured value for the first parameter or a default configured value for the first parameter.

10. The WTRU of claim 1, wherein the processor is further configured to increment a configuration change counter associated with changing the configured value of the first configuration parameter from the first configured value to the second configured value.

11. A method performed by a wireless transmit/receive unit (WTRU), the method comprising:
receiving configuration information from a network, wherein the configuration information associated with a plurality of configuration parameters, and wherein the configuration information indicates one or more of an applicability range for each of the plurality of configuration parameters or a set of default and non-default values for each of the plurality of configuration parameters, wherein each of the plurality of configuration parameters is associated with a respective information element and is used to configure the WTRU for operation or communication with the network;
determining that one or more conditions associated with a first configuration parameter of the plurality of configuration parameters has been met;
changing a configured value of the first configuration parameter from a first configured value to a second configured value based on the one or more conditions being met, wherein the second configured value is one or more of within the applicability range for the first configuration parameter or a non-default value for the first configuration parameter;
sending a report to the network that indicates the second configured value of the first configuration parameter; and
reverting back to the first configured value based on one or more of expiration of a fallback to default value time duration, reception of a first fallback indication from the network, or a fallback to default value condition being met.

12. The method of claim 11, further comprising sending, to the network, a request to change the configured value of the first configuration parameter from the first configured value to the second configured value prior to changing the configured value of the first configuration parameter.

13. The method of claim 12, wherein the first configured value is a default value and the second configured value is a non-default value.

14. The method of claim 11, wherein the one or more conditions comprise reception of a grant or acknowledgment (ACK), an observed key performance indicator (KPI) is within a predetermined range, the observed KPI is greater or less than a predetermined KPI threshold, a remaining time associated with a packet is less than a threshold, a control plane (CP) event has been satisfied, a measured channel condition is within a predetermined range, a measured channel condition is greater than a predetermined threshold, or the measured channel condition is less than a predetermined threshold.

15. The method of claim 11, wherein the configuration information indicates one or more of a max change delta, a reporting delta, a request a change delta, or a key performance indicator (KPI) metric.

16. The method of claim 15, wherein the second configured value is less than the max change delta from the first configured value.

17. The method of claim 11, wherein each of the plurality of configuration parameters comprises any combination of a timer or a counter.

18. The method of claim 11, further comprising sending a second fallback indication to the network that indicates that the WTRU has reverted to the first configured value.

19. The method of claim 11, wherein the first configured value is a previously configured value for the first parameter or a default configured value for the first parameter.

20. The method of claim 11, further comprising incrementing a configuration change counter associated with changing the configured value of the first configuration parameter from the first configured value to the second configured value.
